(19) United States
(12) Patent Application Publication
(10) Pub. No.: US 2010/0257303 A1
(43) Pub. Date: Oct. 7, 2010

(54) SERIAL COMMUNICATION SYSTEM AND ID GRANT METHOD THEREOF

(75) Inventors: Ju-Min Lee, Yongin-si (KR); Duck-Young Jung, Yongin-si (KR); Jei-Hyuk Lee, Yongin-si (KR)

Correspondence Address: CANTOR COLBURN, LLP, 20 Church Street, 22nd Floor, Hartford, CT, 06103, US

(73) Assignee: ATLAB INC., Yongin-si (KR)

(21) Appl. No.: 12/745,719

(22) PCT Filed: May 21, 2008
(86) PCT No.: PCT/KR08/02832

§ 371 Date: Jun. 2, 2010

(30) Foreign Application Priority Data
Dec. 17, 2007 (KR) 10-2007-0132174

(51) Int. Cl. G06F 13/38

(52) U.S. Cl. 710/316

(57) ABSTRACT

Provided are a serial communication system and a method of granting IDs using the system. The serial communication system includes a control unit for transmitting a clock signal via a first communication line and transmitting data including a sub-identification (sub-ID) via a second communication line; and a plurality of cascade-connected semiconductor devices to which the same device ID is granted, wherein each semiconductor device includes a switch for connecting an input terminal and an output terminal in response to a turn-on signal, and stores the data including the sub-ID in response to the clock signal and turns on the switches to sequentially store the sub-ID.

### TECHNICAL FIELD

The present invention relates to a communication system, and more particularly, to a semiconductor device capable of serial bus communications and a method of granting identification (ID) using the same.

### BACKGROUND ART

In order to communicate data using a system, a driver for generating a signal and a receiver for receiving the signal should constitute a kind of communication network. In a typical communication environment, a communication system should be capable of receiving a query signal from one semiconductor device and transmitting/receiving data to/from another semiconductor device in response to the query signal. The communication of signals between the semiconductor devices is enabled by providing a communication link or a channel between the semiconductor devices. An effective method of providing the communication link is to connect all semiconductor devices using a bus structure.

There are various types of bus networks, such as those that employ a point-to-point technique, a multi-drop technique, a multi-point technique, etc.

Multi-drop bus networks may include IEEE1394 (Firewire), inter-integrated circuit (I2C), or an RS-485 bus. Among the multi-drop bus networks, an I2C bus protocol is widely used because it enables a plurality of semiconductor devices to receive and transmit data using a small number of communication lines.

It is necessary to assign device ID to each of a plurality of semiconductor devices in order for them to communicate data. Rather than granting ID to each semiconductor device on an individual basis, it is desirable to be able to grant ID to all semiconductor devices at the same time, without need of separate manipulation by a user.

FIG. 1 is a view showing the construction of a conventional serial communication system. Referring to FIG. 1, the conventional serial communication system includes a main control unit (MCU) 1 and a plurality of semiconductor devices 10, 20, 30, 40, and 50, which are connected to one another.

Construction and operation of the serial communication system shown in FIG. 1 will now be described using an I2C bus protocol.

The MCU 1 is connected to the respective semiconductor devices 10 to 50 using a data line (SDA: Serial DAta) and a clock line (SCL: Serial CLock). Thus, the MCU 1 transmits various data to the respective semiconductor devices 10 to 50, or receives replies from the respective semiconductor devices 10 to 50, via the data line SDA. Also, the MCU 1 generates a reference clock signal required for controlling a data rate and synchronizing signals via the clock line SCL.

The semiconductor devices 10 to 50 may be various semiconductor devices, for example, sensors, digital-to-analog converters (DACs), and memory devices. The semiconductor devices 10 to 50 transmit or receive data in synchronization with a clock signal generated by the MCU 10.

When the MCU 1 generates and outputs a clock pulse indicating the start of transmission, the semiconductor devices 10 to 50, which are connected to the data line SDA and the clock line SCL, receive and recognize the clock pulse and wait for the next data. Thereafter, the MCU 1 transmits to the semiconductor devices 10 to 50 a proper address of the semiconductor device 20 with which the MCU 1 wants to communicate signals, and the semiconductor devices 10 to 50 receive the proper address of the semiconductor device 20 and compare it with their own addresses.

As a result, the second semiconductor device 20 confirms that its own address is identical to the received address, receives the following data, and transmits a reply signal to inform that the data is received without error.

Finally, the MCU 1 receives the rely signal from the second semiconductor device 20 and generates a clock pulse indicating the end of transmission to finish the transmission of signals.

Here, the proper address corresponds to a device ID assigned to each of the semiconductor devices 10 to 50 to distinguish between them. Proper addresses (hereinafter, referred to as ‘device IDs’ of the respective semiconductor devices 10 to 50 should be set before the communication system starts to communicate data. Conventionally, the device IDs are assigned to the respective semiconductor devices 10 to 50 by operating a plurality of switches included in the semiconductor devices 10 to 50 or programming internal memory of the semiconductor devices 10 to 50.

In the conventional serial communication system, a user has to set the switches or to program the internal memory one by one in order to assign different device IDs to the semiconductor devices 10 to 50. However, when the device IDs are set incorrectly, a malfunction may occur in the communication system. Also, when a semiconductor device is mounted in a position that the user cannot directly access, it is difficult to change its device ID. Moreover, it is troublesome to check for repetition or omission of device IDs.

Also, the conventional serial communication system cannot communicate data when semiconductor devices having the same function have the same device ID. In order to solve this problem, different device IDs may be assigned to semiconductor devices having the same function. In this case, however, since the number and kind of device IDs are limited, it is impossible to connect a large number of semiconductor devices. In addition, data communication is complicated when semiconductor devices have the same function and different device IDs. Therefore, it is necessary to develop a new ID granting apparatus and method for granting the same device ID to a plurality of semiconductor devices.

### DISCLOSURE OF INVENTION

### Technical Problem

The present invention is directed to a serial communication system that grants sub-identifications (sub-IDs) to enable serial bus communication among a plurality of semiconductor devices having the same device ID.

Also, the present invention is directed to a method of granting sub-IDs to enable serial bus communication among a plurality of semiconductor devices having the same device ID.

### Technical Solution

One aspect of the present invention provides a serial communication system comprising a control unit and a plurality of cascade-connected semiconductor devices. The control unit transmits a clock signal via a first communication line and data including a sub-ID via a second communication line. The same device ID is granted to every semiconductor device. Each of the semiconductor devices includes a switch for connecting an input terminal and an output terminal in response to a turn-on signal. The semiconductor devices store the data including the sub-ID in response to a clock signal and turn on the switches to sequentially store the sub-ID.

The semiconductor devices may be input devices.

The input devices may be touch sensors.

In an exemplary embodiment of the present invention, the semiconductor devices may include an initial stage and a next stage cascade-connected to the initial stage, the initial and next stages may be connected in common to the first communication line, the second communication line may be connected to the input terminal of an initial stage, and the output terminal of the initial stage may be connected to the input terminal of the next stage, so that the initial stage stores the sub-ID in response to the clock signal and turns on the switch to connect the second communication line and the next stage, and the next stage sequentially stores the sub-ID.

In another exemplary embodiment of the present invention, the semiconductor devices may include an initial stage and a next stage cascade-connected to the initial stage, the initial and next stages may be connected in common to the second communication line, the first communication line may be connected to the input terminal of an initial stage, and the output terminal of the initial stage may be connected to the input terminal of the next stage, so that the initial stage stores the sub-ID in response to the clock signal and turns on the switch to connect the first communication line and the next stage, and the next stage sequentially stores the sub-ID.

Each of the semiconductor devices may include: a clock terminal to which the clock signal is input; and a controller for turning off the switch when a power voltage is initially applied, storing the sub-ID in response to the received data, controlling the switch, and outputting data or an acknowledge signal indicating that data is received without errors.

Each of the semiconductor devices may include: an input data analyzer for receiving and analyzing the data and outputting the analyzed data to the controller; and an output data generator for receiving the signal output from the controller and outputting the signal via a predetermined protocol.

The data may be a sub-ID storage protocol for storing the sub-ID.

The sub-ID storage protocol may include: a start signal indicating the beginning of data transmission; the device ID; a command instructing operation of the corresponding semiconductor device; the sub-ID; the acknowledge signal; and an end signal indicating the completion of data transmission.

The acknowledge signal may be generated and output whenever the corresponding semiconductor device receives each of the device ID, the command, and the sub-ID.

The controller may compare the device ID of the sub-ID storage protocol with the set device ID using the sub-ID storage protocol, wherein when the device ID of the sub-ID storage protocol is identical to the set device ID, the controller confirms whether the command is a command to store the sub-ID, and when the command is the command to store the sub-ID and the sub-ID is not stored, the controller stores the sub-ID of the received data as the sub-ID of the semiconductor device and turns on the switch.

The controller may erase the sub-ID stored in each of the semiconductor devices, turn off the switch, re-store the sub-ID, and turn on the switch, using a sub-ID reset protocol for resetting the sub-ID.

The switch may be turned off when a power voltage is initially applied or the sub-ID is not stored, and turned on when the sub-ID is stored.

The serial communication system may further include at least one control unit.

The serial communication system may further include at least one second semiconductor device connected to the semiconductor devices in parallel and assigned a different device ID. Each of the second semiconductor devices may receive the clock signal and the data.

Another aspect of the present invention provides a method of granting IDs in a serial communication system. The method includes: outputting, by a control unit, a clock signal and data including a sub-ID; and receiving, by a semiconductor device, the data, storing the sub-ID of the received data excluding a set device-ID, and turning on a switch to transmit the data to the next stage.

Storing the ID and controlling the switch may include: detecting a start signal indicating the beginning of data transmission in response to the clock signal, and receiving the device ID included in the data; setting and storing the sub-ID of the data; turning on the switch; and finishing storing the sub-ID and standing by to receive next data.

Storing the sub-ID of the data may include: confirming the received device ID and a command; and confirming the stored sub-ID and storing the sub-ID of the data.

Confirming the device ID and the command may include: comparing the set device ID with the received device ID and receiving the device ID included in the data when the set device ID is not identical to the received device ID; receiving the command included in the data; and confirming whether the received command is a command to store the sub-ID, and performing a subsequent step when the received command is a command to store the sub-ID.

Confirming the stored sub-ID and storing the sub-ID of the data may include: confirming whether the sub-ID is stored, determining that the received command is erroneous, finishing storing the sub-ID, and standing by to receive next data when the sub-ID is stored; receiving the sub-ID included in the data when the sub-ID is not stored; and storing the received sub-ID.

### Advantageous Effects

According to a serial communication system and an ID grant method thereof of the present invention, sub-IDs can be granted to a plurality of semiconductor devices having the same device ID, so that each of the semiconductor devices can be selected to communicate data using the device ID and the sub-IDs. This is in contrast to a conventional serial communication system in which the same device ID cannot be granted to a plurality of semiconductor devices performing the same function, and the semiconductor devices can not communicate data through the conventional system. Also, the serial communication system according to the present invention can automatically grant the sub-IDs to the respective semiconductor devices having the same device ID. Furthermore, the serial communication system according to the present invention can be connected to a conventional serial communication system and communicate data with a larger number of devices using a smaller number of addresses.

### BRIEF DESCRIPTION OF THE DRAWINGS

FIG. 1 is a view showing the construction of a conventional serial communication system;

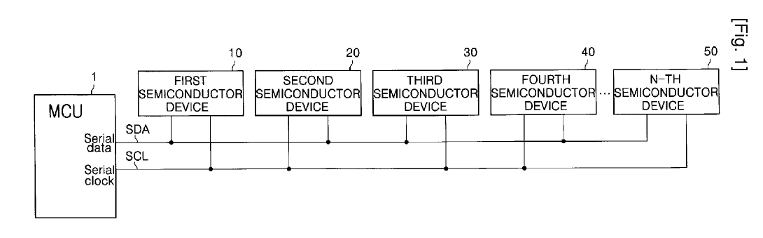

FIG. 2 is a view showing the construction of a semiconductor device according to an exemplary embodiment of the present invention;

FIG. 3 is a view showing the construction of a serial communication system according to an exemplary embodiment of the present invention;

FIG. 4 is a diagram of a sub-ID storage protocol of the serial communication system shown in FIG. 3, according to an exemplary embodiment of the present invention;

FIG. 5 is a flowchart of a method of granting IDs in the serial communication system shown in FIG. 3;

FIG. 6 is a view showing the construction of a serial communication system according to another exemplary embodiment of the present invention;

FIG. 7 is a block diagram of a touch sensor shown in FIG. 6; and

FIG. 8 is a cross-sectional view of a touch sensor shown in FIG. 7.

### MODE FOR THE INVENTION

Hereinafter, exemplary embodiments of the present invention will be described in detail. However, the present invention is not limited to the exemplary embodiments disclosed below, but can be implemented in various modified forms. The present exemplary embodiments are provided to fully enable those of ordinary skill in the art to embody and practice the present invention.

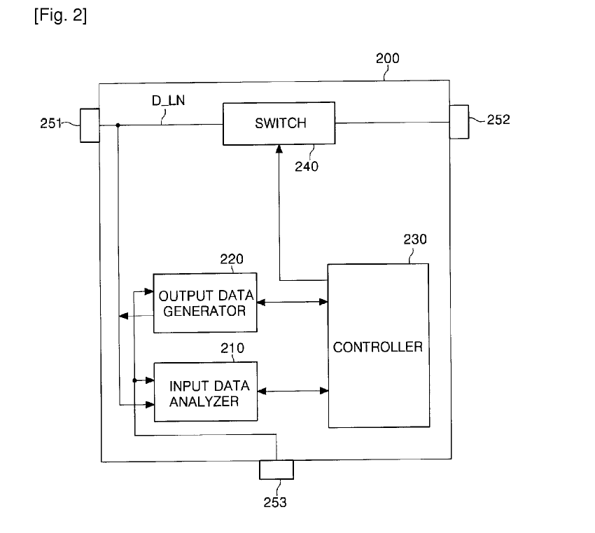

FIG. 2 is a view showing the construction of a semiconductor device 200 according to an exemplary embodiment of the present invention. The semiconductor device 200 includes a switch 240, a controller 230, an input data analyzer 210, an output data generator 220, input/output terminals 251 and 252, and a clock terminal 253.

Functions of blocks shown in FIG. 2 will now be described.

The controller 230 outputs a control signal for controlling the input data analyzer 210, receives an output signal of the input data analyzer 210, analyzes the received data, performs a specific operation on the data in response to a command or stores the data, and outputs the data to the output data generator 220. Also, the controller 230 has an additional internal storage (not shown), stores a device identification (device ID) and a sub-ID, and outputs a signal for turning on or off the switch 240 depending on the absence or presence of the sub-ID. In this case, when a power voltage is initially applied to the controller 230, the controller 230 turns off the switch 240 and then performs the above-described operations.

Here, the device ID of the semiconductor device 200 is granted in order to discriminate the semiconductor device 200 from other semiconductor devices. Sub-IDs are respectively granted to semiconductor devices having the same device ID in order to distinguish between the semiconductor devices having the same device ID during communications.

The switch 240 connects the input/output terminals 251 and 252 so that a data line D_LN of the semiconductor device 200 is connected to other semiconductor devices. When power voltage is initially applied, the switch 240 remains turned off. When the sub-IDs are set, the switch 240 is turned on to thereby connect the input/output terminals 251 and 252. The switch 240 is turned on or off in response to the control signal output from the controller 230.

The input data analyzer 210 receives data from a micro controller unit (MCU) or other semiconductor devices via the data line D_LN in response to a reference clock signal applied via the clock terminal 253, analyzes the received data, outputs the analyzed data to the controller 230, and receives a control signal from the controller 230.

The output data generator 220 receives output data from the controller 230, generates data having a predetermined protocol corresponding to the output data, and outputs the data having the predetermined protocol to the data line D_LN in response to the reference clock signal applied via the clock terminal 253. One example of data from the controller 230 is to make the output data generator 220 tri-state when the controller 230 makes the switch 240 turn on.

In this case, it is obvious that the controller 230 can control the input data analyzer 210 and the output data generator 220. It is also obvious that the controller 230 may include the input data analyzer 210 and the output data generator 220.

Although only operation of the controller 230, which is associated with generation of IDs, is described above, the controller 230 may receive data related with proper functions (not shown)—e.g., control of touch sensors, external switches, and light sources-included in the semiconductor device 200 and process the received data. Up to now, for simplicity, the output generator 220 is connected to the input terminal 251, but it is obvious that the output generator 220 is connected to the output terminal 252.

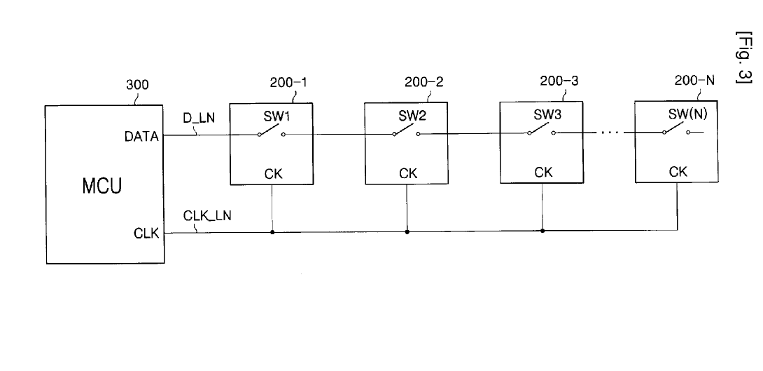

FIG. 3 is a view showing the construction of a serial communication system according to an exemplary embodiment of the present invention. In FIG. 3, an MCU 300 and semiconductor devices 200-1 to 200-N having the same device ID are connected to one another.

Construction of the serial communication system shown in FIG. 3 will now be described with reference to FIG. 2.

The MCU 300 is connected to the semiconductor devices 200-1 to 200-N via the data line D_LN and a clock line CLK_LN. The MCU 300 transmits various data to the semiconductor devices 200-1 to 200-N or receives replies from the semiconductor devices 200-1 to 200-N via the data line D_LN. Also, the MCU 300 generates a reference clock signal for controlling a data rate and synchronizing signals via the clock line CLK_LN.

The semiconductor devices 200-1 to 200-N may be various semiconductor devices and may transmit or receive data in synchronization with a clock signal generated by the MCU 300.

An N number of semiconductor devices 200-1 to 200-N, that is, a first semiconductor device 200-1 through an N-th semiconductor device 200-N, are sequentially disposed far away from the MCU 300. The semiconductor devices 200-1 to 200-N share the clock line CLK_LN and the data line D_LN. The data line D_LN is connected to the semiconductor devices 200-1 to 200-N through switches SW1 to SW(N), respectively.

Also, the semiconductor devices 200-1 to 200-N receive a clock signal from the MCU 300 via the clock line CLK_LN, receive sub-IDs other than a device ID from the MCU 300 using a communication protocol in response to the clock signal, and sequentially store the sub-IDs. When the sub-ID is stored in one of the semiconductor devices 200-1 to 200-N, the switches SW are connected so as to connect a semiconductor device of a next stage and the data line D_LN.

The semiconductor devices 200-1 to 200-N can communicate data with one another or the MCU 300 using the stored sub-IDs.

Thus, the semiconductor devices 200-1 to 200-N having the same device ID can communicate data with one another by granting different sub-IDs to the semiconductor devices 200-1 to 200-N.

Operation of the serial communication system shown in FIG. 3 will now be described with reference to FIG. 2.

When a power voltage is applied, the MCU 300 grants different sub-IDs to the semiconductor devices 200-1 to 200-N having the same device ID so as to distinguish between the semiconductor devices 200-1 to 200-N.

When the voltage is applied, the switches SW1 to SW(N) of the semiconductor devices 200-1 to 200-N remain turned off.

Thereafter, the MCU 300 outputs data including the device ID, internally generated sub-IDs, and a command to the data line D_LN using a predetermined protocol. Thus, the input data receiver 210 of the first semiconductor device 200-1 connected to the MCU 300 via the data line D_LN receives output data of the MCU 300, analyzes the respectively received data, and outputs the analyzed data to the controller 230. The controller 230 sequentially receives the device ID, the sub-IDs, and the command, and generates and outputs an acknowledge bit in reply to each of the received data. The acknowledge bit indicates that each of the data is received without errors. The output data generator 220 transmits the output data of the controller 230 to the data line D_LN.

In this case, the MCU 300 outputs a start signal indicating the beginning of data transmission before the MCU 300 outputs data, and outputs an end signal indicating the completion of data transmission after the MCU 300 outputs all data. When the start signal is applied, the semiconductor devices 200-1 to 200-N stand by to receive data. When the end signal is applied, the semiconductor devices 200-1 to 200-N stand by to receive a new start signal.

Initially, the controller 230 receives the start signal from the MCU 300, receives a device ID, and compares its own device ID with a device ID of analyzed data.

When the device ID of the controller 230 is identical to the device ID of the analyzed data, the first semiconductor device 200-1 generates and outputs an acknowledge bit indicating that the device ID is received without errors.

When the device ID of the controller 230 is not identical to the device ID of the analyzed data, the first semiconductor device 200-1 finishes operation and stands by to receive a start signal instead of outputting the acknowledge bit.

The MCU 300 receives the acknowledge bit and outputs a command, and the controller 230 receives and confirms the command. Thus, when the received command is a command to store a sub-ID, the controller 230 confirms whether the sub-ID is stored.

When the sub-ID is not stored, the first semiconductor device 200-1 generates and outputs an acknowledge bit indicating that data is received without errors and receives the next data.

When the sub-ID is stored, the first semiconductor device 200-1 decides that the command is in error and does not output the acknowledge bit. Also, the first semiconductor device 200-1 finishes operation and stands by to receive a start signal.

The MCU 300 receives the acknowledge bit and outputs the sub-ID. The controller 230 receives the sub-ID, stores the received sub-ID as its own sub-ID, and turns on the switch SW1. Thereafter, the first semiconductor device 200-1 generates and outputs an acknowledge bit indicating that the sub-ID is received without errors.

In other words, the first semiconductor device 200-1 confirms the stored sub-ID when the device ID of the first semiconductor device 200-1 is identical to a device ID of analyzed data and the command to store the sub-ID is received. When it is determined that the sub-ID is stored, the first semiconductor device 200-1 finishes operation and stands by to receive the next data. When it is determined that the sub-ID is not stored, the first semiconductor device 200-1 receives the sub-ID, stores the sub-ID, and turns on the switch SW1.

When the switch SW1 is turned on, the MCU 300 is connected to the second semiconductor device 200-2 through the data line D_LN.

After the MCU 300 receives the acknowledge bit ACK, the MCU 300 outputs an end signal indicating that first data is completely transmitted, and generates and outputs second data including a second sub-ID to grant the second sub-ID to the second semiconductor device 200-2.

In this case, the second data output from the MCU 300 is transmitted to both the first and second semiconductor devices 200-1 to 200-2.

The MCU 300 outputs a start signal and a device ID. The controllers 230 of the respective semiconductor devices 200-1 and 200-2 compare their own device ID with the device ID of the analyzed data.

When the device ID of the semiconductor devices 200-1 and 200-2 is identical to the device ID of the analyzed data, each of the semiconductor devices 200-1 and 200-2 generates and outputs an acknowledge bit indicating that the device ID is received without errors.

The MCU 300 receives the acknowledge bit and outputs a command, and the controllers 230 of the respective semiconductor devices 200-1 and 200-2 receive and confirm the command. When it is determined that the command is a command to store a second sub-ID, the semiconductor devices 200-1 and 200-2 confirm whether the second sub-ID is stored.

In this case, since the first semiconductor device 200-1 stores the sub-ID, the first semiconductor device 200-1 determines that the command is not for the first semiconductor device 200-1 and does not output an acknowledge bit. Also, the first semiconductor device 200-1 finishes operation and stands by to receive a start signal.

Since the second semiconductor device 200-2 stores no sub-ID, the second semiconductor device 200-2 generates and outputs an acknowledge bit and receives the next data.

The MCU 300 receives the acknowledge bit from the second semiconductor device 200-2 and outputs the second sub-ID. The second semiconductor device 200-2 receives the second sub-ID, stores the second sub-ID as its own sub-ID, and turns on the switch SW2. Thereafter, the second semiconductor device 200-2 generates and outputs an acknowledge bit indicating that the second sub-ID is received without errors.

When the switch SW2 is turned on, the MCU 300 is connected to the third semiconductor device 200-3 through the data line D_LN.

When each of the semiconductor devices 200-1 to 200-N receives a command other than the command to store the sub-ID, each of the semiconductor devices 200-1 to 200-N compares its own sub-ID with the received sub-ID. When the sub-ID of each of the semiconductor devices 200-1 to 200-N is identical to the received sub-ID, the corresponding semiconductor device executes the command to output data or stands by to receive the next data, receives the next data, and outputs a command execution result.

By repeating the above-described steps, the third to N-th semiconductor devices 200-3 to 200-N also store sub-IDs output from the MCU 300.

In this case, when the MCU 300 cannot receive the acknowledge bit in a predetermined amount of time, the MCU 300 outputs an end signal and then a start signal together with data of a preset number. In this case, when the MCU 300 does not receive the acknowledge bit, the MCU 300 determines that there is no further semiconductor device having the same device ID, finishes an operation of transmitting a sub-ID, and starts performing an operation suited for the purpose of the semiconductor devices 200-1 to 200-N using a protocol.

Also, the semiconductor devices 200-1 to 200-N having the same device ID can receive output data of the MCU 300, analyze the received data, and compare the data with the device ID because the semiconductor devices 200-1 to 200-N may be connected to a semiconductor device having a different device ID. When it is determined that there is no semiconductor device having the different device ID, the device ID may not be used in the above-described process.

It is described as an example above that the semiconductor devices 200-1 to 200-N share the clock line CLK_LN connected to the MCU 300, and the switches SW1 to SW(N) of the semiconductor devices 200-1 to 200-N share the data line D_LN connected to the MCU 300. However, it is obvious that the semiconductor devices 200-1 to 200-N may share the data line D_LN connected to the MCU 300, and the switches SW1 to SW(N) of the semiconductor devices 200-1 to 200-N may share the clock line CLK_LN connected to the MCU 300.

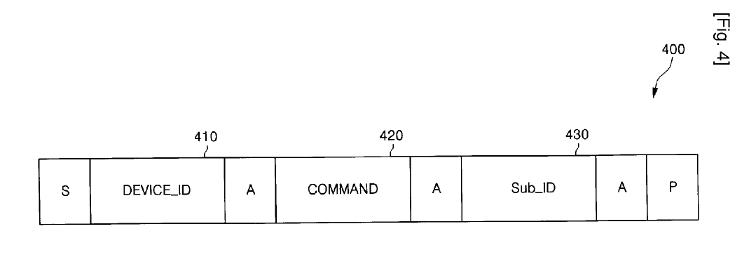

FIG. 4 is a diagram of a sub-ID storage protocol of the serial communication system shown in FIG. 3, according to an exemplary embodiment of the present invention.

The sub-ID storage protocol shown in FIG. 4 will now be described with reference to FIGS. 2 and 3.

The sub-ID storage protocol 400 includes a 1-bit start signal S indicating the beginning of ID set data, a 1-bit acknowledge bit A, a 1-bit end signal P, a device ID 410, a command 420, and a sub-ID 430.

By the start signal S, a semiconductor can be informed of a start of protocol so that the semiconductor devices 200-1 to 200-N stand by to receive data.

When a semiconductor device receives data during the period of the acknowledge bit A, it generates and outputs the acknowledge bit A to another semiconductor device that transmits the data.

The device ID 410 is granted to the semiconductor devices 200-1 to 200-N in order to distinguish them from other semiconductor devices. In this case, it is possible to select all the semiconductor devices 200-1 to 200-N having the same device ID 410. In another case, the device ID 410 may be granted to a single semiconductor device so as to select only the single semiconductor device.

The command 420 is used to designate operations (e.g., read, write, and setting operations) of a semiconductor device.

The sub-ID 430 is granted to the semiconductor devices 200-1 to 200-N having the same device ID 410 to distinguish between them. A semiconductor device to which data is transmitted can be selected from among the semiconductor devices 200-1 to 200-N having the same device ID 410 using the sub-ID 430.

By the end signal S, a semiconductor can be informed of an end of protocol so that the semiconductor devices 200-1 to 200-N can finish receiving data.

When a voltage is applied, the MCU 300 outputs the sub-ID storage protocol including the start signal S, the acknowledge bit A, the end signal P, the device ID 410, the command 420, and the sub-ID 430 to the data line D_LN in order to set the sub-ID of a semiconductor device that is connected to the MCU 300 through the data line D_LN and the clock line CLK_LN. When the semiconductor device receives the sub-ID storage protocol, the input data analyzer 210 of the semiconductor device sequentially analyzes data and outputs the analyzed data to the controller 230. Then, the controller 230 processes the analyzed data and generates and outputs the acknowledge bit A during the period of the acknowledge bit A.

Although it is described for brevity that the sub-ID storage protocol includes a 1-bit start signal, a 1-bit acknowledge bit, and a 1-bit end signal, the sub-ID storage protocol may include a multi-bit start signal, a multi-bit acknowledge bit, and a multi-bit end signal.

It is described above that the acknowledge bit A is output whenever each of the device ID 410, the command 420, and the sub-ID 430 is received, but the acknowledge bit A may be output only once before the end signal P is applied.

In the present embodiment, only the sub-ID storage protocol is described. However, it is obvious that various protocols, such as a data storage protocol, a data read protocol, and a sub-ID reset protocol, may be determined and used to communicate data.

Furthermore, it is described that the semiconductor device operates whenever each of the device ID 410, the command 420, and the sub-ID 430 is received. However, after the semiconductor device receives and stores all of the device ID 410, the command 420, and the sub-ID 430 of the sub-ID storage protocol, it may operate using the stored data.

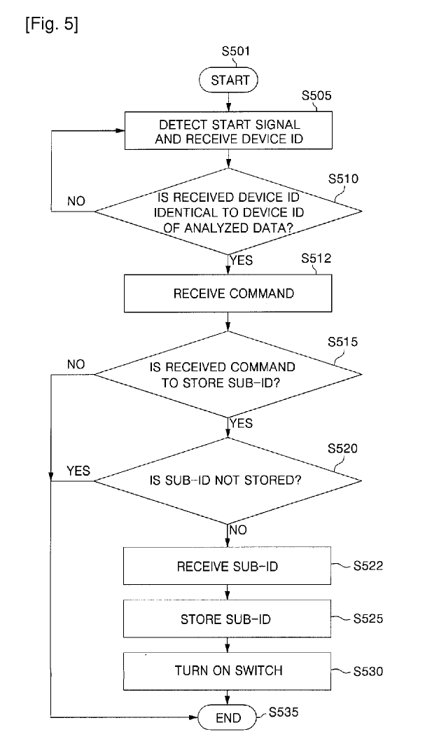

FIG. 5 is a flowchart of a method of granting IDs in the serial communication system shown in FIG. 3.

Hereinafter, a method of granting IDs to the semiconductor devices 200-1 to 200-N of the serial communication system shown in FIG. 3 will be described with reference to FIGS. 2 through 5.

In the description, a process of receiving the sub-ID storage protocol 400 and a process of generating and outputting the acknowledge bit A are omitted.

When a power voltage is applied, the switches SW1 to SW(N) of the semiconductor devices 200-1 to 200-N remain turned off, and the MCU 300 sequentially outputs the sub-ID storage protocol 400 including the device ID 410, the command 420, and the sub-ID 430 to the data line D_LN in step S501.

After the start signal S is applied, the corresponding semiconductor device receives the device ID 410 from the MCU 300 using the sub-ID storage protocol 400 in step S505.

The controller 230 of the semiconductor device compares the received device ID 410 with a set device ID of the semiconductor memory device in step S510.

As a result, when the set device ID of the semiconductor device is not identical to the received device ID 410, the semiconductor device stands by to receive the start signal S from the MCU 300 again in step S505.

In contrast, when the set device ID 410 of the semiconductor device is identical to the received device ID 410, the semiconductor device receives and performs the command 420 in step S512.

The controller 230 of the semiconductor memory device determines that the received command 420 is a command to store the sub-ID 430 in step S515. If the received command 420 is not the command to store the sub-ID 430, the controller 230 proceeds to steps 535. However, if the received command is the command to store the sub-ID 430, the controller 230 proceeds to steps 520.

In the steps 520, the controller 230 confirms whether there is sub-ID stored in the semiconductor device.

In this case, if the stored sub-ID exists in the semiconductor memory device, the controller 230 of the semiconductor device proceeds to the steps 535 to finish the operation of storing the sub-ID 430.

If the sub-ID 430 does not exist in step S520, the controller 230 receives the sub-ID from the MCU 300 using the sub-ID storage protocol 400 in steps 522. The controller 230 stores the sub-ID in steps 525.

After the sub-ID 430 is set to the semiconductor device, the switch 240 is turned on to connect the next semiconductor device and the data line D_LN in step S530.

Thereafter, the semiconductor device receives the end signal P, finishes operation, and stands by for the start signal S in step S535.

The sub-ID 430 may be granted to the semiconductor device only once when a power voltage is initially applied. Alternatively, the sub-ID 430 may be granted to the semiconductor device whenever power is interrupted and supplied again to the MCU 300 and the semiconductor device. Also, it is obvious that after the sub-IDs of all the semiconductor devices 200-1 to 200-N are erased and the switches 240 of the semiconductor devices 200-1 to 200-N are turned off in response to a command of protocol, the sub-IDs 430 may be granted to the semiconductor devices 200-1 to 200-N again.

Although not described and shown in the present embodiment, the serial communication system according to the present invention may include two or more MCUs, communicate data by setting a protocol between MCUs and semiconductor devices, and communicate signals between semiconductor devices.

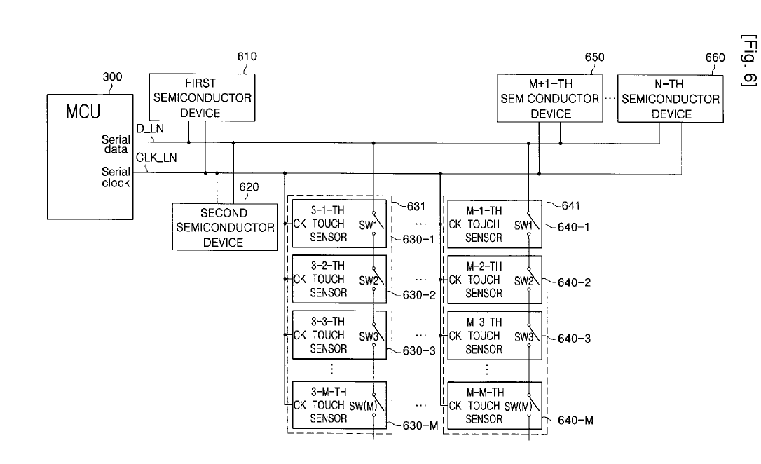

FIG. 6 is a view showing the construction of a serial communication system according to another exemplary embodiment of the present invention. The serial communication system includes an MCU 300, a plurality of semiconductor devices 610, 620, 650, and 660 having different device IDs, a first touch sensor group 631 having a first identical device ID, and a second touch sensor group 641 having a second identical device ID.

Since the serial communication system shown in FIG. 6 has the same construction and performs the same operations as shown in FIGS. 2, 3, 4, and 5, it will be described with reference to FIGS. 2, 3, 4, and 5.

The MCU 300 is connected to the respective semiconductor device 610, 620, 650, and 660 through a data line D_LN and a clock line CLK_LN. The MCU 300 generates a reference clock signal for controlling a data rate and synchronizing signals via the clock line CLK_LN. The MCU 300 transmits various data to the semiconductor devices 610, 620, 631, 641, 650, and 660, or receives replies from the semiconductor devices 610, 620, 631, 641, 650, and 660, via the data line D_LN.

The semiconductor devices 610, 620, 650, and 660 may be various semiconductor devices, such as input devices or output devices, and may transmit or receive data in synchronization with the reference clock signal output from the MCU 300 via the clock line CLK_LN.

The first touch sensor group 631 may include a plurality of touch sensors 630-1 to 630-M, and the second touch sensor group 641 may include a plurality of touch sensors 640-1 to 640-4. Each of the touch sensors 630-1 to 630-M and 640-1 to 640-M includes a touch pad (not shown) and a controller 230. The controller 230 of each of the touch sensors 630-1 to 630-M and 640-1 to 640-M determines if a touch object (not shown) contacts the touch pad, generates contact data, and transmits or receives the contact data in synchronization with the reference clock signal generated by the MCU 300.

The touch sensors 630-1 to 630-M of the first touch sensor group 631 have the first identical device ID 410, and the touch sensors 640-1 to 640-M of the second touch sensor group 641have the second identical device ID 410. However, the device ID 410 of the first touch sensor group 631 is different from the device ID 410 of the second touch sensor group 641. Also, the device IDs 410 of the first and second touch sensor groups 631 and 641 are different from the device ID 410 of the semiconductor devices 610, 620, 650, and 660.

The MCU 300 and the semiconductor devices 610, 620, 650, and 660 transmit and receive a command 420 and data (not shown) using a communication protocol (not shown) that does not include the sub-ID 430. Also, the MCU 300 and the first and second touch sensor groups 631 and 641 transmit and receive the command 420 and the data using a communication protocol including the sub-ID 430.

For example, each of the semiconductor devices 610, 620, 650, and 660 receives the device ID 410 of the communication protocol and compares a device ID of the corresponding semiconductor device with the received sub-ID 430. Thus, when the device ID of each of the semiconductor devices 610, 620, 650, and 660 is identical to the received sub-ID 430, the corresponding semiconductor device disregards the subsequently received sub-ID 430 and stores or transmits data in response to the command 420.

Each of the touch sensors 630-1 to 630-M and 640-1 to 640-M of the first and second touch sensor groups 631 and 641 receives the device ID 410 of the communication protocol and compares a device ID 410 of the corresponding touch sensor with the received device ID 410. Thus, when the device ID 410 of the touch sensor is identical to the received device ID 410, the touch sensor stores the received data or transmits each contact data in response to the command 420.

A process of granting sub-IDs to the touch sensors 630-1 to 630-M and 640-1 to 640-M of the first and second touch sensor groups 631 and 641 can be understood with reference to FIG. 5 and thus, a description thereof will be omitted.

Also, it is obvious that each of the touch sensors 630-1 to 630-4 and 640-1 to 640-4 of the first and second touch sensor groups 631 and 641 can communicate data with each of the semiconductor devices 610, 620, 650, and 660.

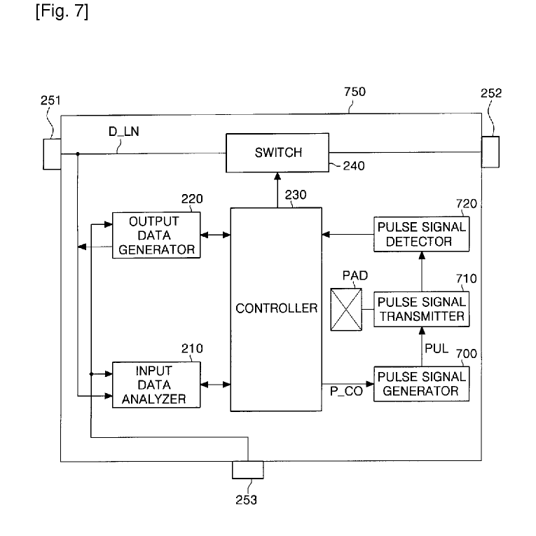

FIG. 7 is a block diagram of the touch sensor shown in FIG. 6, which includes a switch 240, a controller 230, an input data analyzer 210, an output data generator 220, input/output terminals 251 and 252, a clock terminal 253, a pulse signal generator 700, a pulse signal transmitter 710, a pulse signal detector 720, and a touch pad PAD.

Construction and operation of the touch sensor 750 shown in FIG. 7 will now be described with reference to FIGS. 2 and 6.

Constructions and operations of the switch 240, the output data generator 220, the input data analyzer 210, and the controller 230 of the touch sensor 750 shown in FIG. 7 are the same as in FIG. 2 except that the controller 230 performs not only the control function shown in FIG. 2 but also a touch sensor control function. Thus, a description of these components will be omitted below.

The pulse signal generator 700 determines a pulse width of a pulse signal PUL in response to a control signal P_CO transmitted from the controller 230, and generates the pulse signal PUL with the determined pulse width.

The pulse signal transmitter 710 includes a touch pad PAD that is contacted by a touch object with a predetermined capacitance. When the touch pad PAD is not contacted by the touch object, the pulse signal PUL is directly transmitted to the pulse signal detector 720. However, when the touch pad PAD is contacted by the touch object, the pulse signal PUL is applied to the touch pad PAD and not to the pulse signal detector 720.

In this case, when the touch pad PAD is contacted by the touch object, the pulse signal PUL is delayed in proportion to the capacitance of the touch object, and the delayed pulse signal PUL may be output to the pulse signal detector 720.

The pulse signal detector 720 detects the pulse signal PUL transmitted by the pulse signal transmitter 710 and informs the controller 230 of a detection result.

In this case, the pulse signal detector 720 may receive a clock signal from the pulse signal generator 700, receive the delayed pulse signal PUL, compare the two signals, and output a comparison result.

In addition to the control function shown in FIG. 2, the controller 230 generates and outputs contact data T_S indicating a state of contact with the touch object based on the detection result of the pulse signal detector 720. As described above with reference to FIGS. 2 and 6, the controller 230 outputs the touch data T_S to the data line D_LN through the output data generator 220 included in the touch sensor 750.

The touch sensor 750 may include at least one pulse signal generator 720, at least one pulse signal transmitter 710, at least one pulse signal detector 720, and at least one touch pad PAD so as to at least one touch signal. Also, the touch pad PAD may be provided outside the touch sensor 750. Also, although the touch sensor 750 is described in the present exemplary embodiment, it may be replaced by any input device.

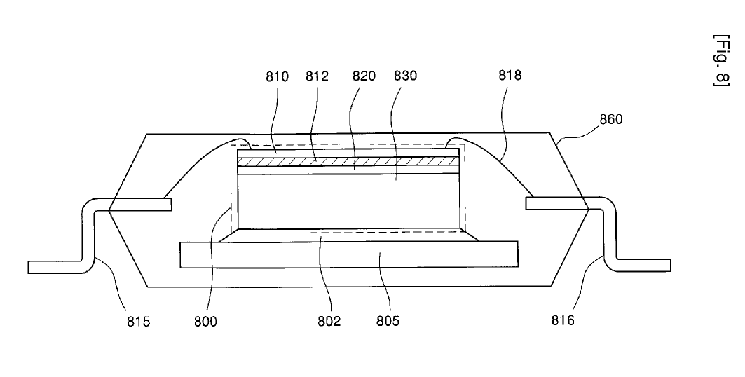

FIG. 8 is a cross-sectional view of the touch sensor shown in FIG. 7, which includes a touch sensing unit 800, an epoxy resin 802, a die-bond pad 805, first and second lead frames 815 and 816, a bonding wire 818, and a semiconductor package 860. The touch sensing unit 800 includes a touch pad 810, an insulating layer 812, a metal layer 820, and a die 830.

Construction of the touch sensor shown in FIG. 8 will now be described with reference to FIGS. 2 and 7.

When the touch pad 810 is contacted by a touch object, the touch pad 810 generates a contact signal indicating a change in an electrical state.

The insulating layer 812 electrically insulates the touch pad 810 from the metal layer 820.

The metal layer 820 may be a capaciflector. When a signal of the same potential as a signal applied to the touch pad 810 is applied to the metal layer 820, the metal layer 820 reduces parasitic capacitance between the insulating layer 812 and the touch pad 810. Thus, when the touch pad 810 is contacted by the touch object, a change in capacitance can be increased, thereby increasing contact sensitivity.

Here, the capaciflector is a kind of a sensor in which a reflector is interposed between electrodes of a sensing substrate and a ground substrate so that an electric field goes outward from one electrode to the other electrode. The capaciflector uses the electric field to sense objects that come close to it. The capaciflector operates on the same principle as ordinary capacitive sensors, that is, on the principle that when an object with a different dielectric constant is inserted into an electric field, capacitance varies.

The die 830 receives the contact signal generated by the touch pad 810, determines if the touch pad 810 is contacted by the touch object based on the contact signal, generates contact data, transmits the contact data or receives data required by the touch sensor, and connects the next touch sensor and the data line D_LN.

The die 830 includes a pulse signal generator 700, a pulse signal transmitter 710, a pulse signal detector 720, a controller 230, an output data generator 220, an input data analyzer 210, and a switch 240, which have the same functions as shown in FIG. 7. Thus, a description of the functions of these components will be omitted below.

The epoxy resin 802 is an insulating resin used to adhere and fix the die 830 to the touch pad 810.

The die-bond pad 805 fixes the die 830 and dissipates heat generated by the die 830.

The bonding wire 818 is electrically connected to the first and second lead frames 815 and 816 so that input/output terminals of circuits of the die 830 are connected to an external system.

The semiconductor package 860 packages the touch pad 810, the die 830, the epoxy resin 802, the first and second lead frames 815 and 816, and the bonding wire 820 using an insulating material, such as a ceramic material, to protect them from external factors and facilitate the functions of the die 830.

Accordingly, the touch sensor according to the present embodiment can transmit/receive data to/from external systems. In particular, since the touch sensor includes the touch sensing unit 800, when the touch pad 810 is contacted by the touch object, the touch sensor can detect the contact, generate contact data, and externally transmit the contact data.

In the serial communication system according to the present embodiment, even if an

MCU, a plurality of semiconductor devices having different device IDs, and a plurality of semiconductor devices having the same device ID are connected to one another, sub-IDs can be granted to the semiconductor devices having the same device ID so that the MCU, the semiconductor devices having different device IDs, and the semiconductor devices having the same device ID can transmit and receive data.

While the invention has been shown and described with reference to exemplary embodiments thereof, it will be understood by those skilled in the art that various changes in form and details may be made therein without departing from the spirit and scope of the invention as defined by the appended claims.

1. A serial communication system comprising:
a control unit for transmitting a clock signal via a first communication line and transmitting data including a sub-identification (sub-ID) via a second communication line; and
a plurality of cascade-connected semiconductor devices which have the same device ID, wherein each semiconductor device includes a switch for connecting an input terminal and an output terminal in response to a turn-on signal, and stores the data including the sub-ID in response to the clock signal and turns on the switch to sequentially store the sub-ID.

2. The system according to claim 1, wherein at least one semiconductor device is used for input devices.

3. The system according to claim 2, wherein the input devices are touch sensors.

4. The system according to claim 1, wherein the semiconductor devices comprise an initial stage and a next stage cascade-connected to the initial stage, the initial and next stages are connected in common to the first communication line, the second communication line is connected to the input terminal of an initial stage, and the output terminal of the initial stage is connected to the input terminal of the next stage, so that the initial stage stores the sub-ID in response to the clock signal and turns on the switch to connect the second communication line and the next stage, and the next stage sequentially stores the sub-ID.

5. The system according to claim 1, wherein the semiconductor devices comprise an initial stage and a next stage cascade-connected to the initial stage, the initial and next stages are connected in common to the second communication line, the first communication line is connected to the input terminal of an initial stage, and the output terminal of the initial stage is connected to the input terminal of the next stage, so that the initial stage stores the sub-ID in response to the clock signal and turns on the switch to connect the first communication line and the next stage, and the next stage sequentially stores the sub-ID.

6. The system according to claim 4, wherein each of the semiconductor devices further comprises:
a clock terminal to which the clock signal is input; and
a controller for turning off the switch when a power voltage is initially applied, storing the sub-ID in response to a received data, controlling the switch, and outputting data or an acknowledge signal indicating that data is received without errors.

7. The system according to claim 6, wherein each of the semiconductor devices further comprises:
an input data analyzer for receiving and analyzing the data and outputting the analyzed data to the controller; and
an output data generator for receiving the signal output from the controller and outputting the signal via a predetermined protocol.

8. The system according to claim 7, wherein the data is a sub-ID storage protocol for storing the sub-ID.

9. The system according to claim 8, wherein the sub-ID storage protocol comprises:
a start signal indicating the beginning of data transmission;
the device ID;
a command instructing operation of the corresponding semiconductor device;
the sub-ID;
the acknowledge signal; and
an end signal indicating the completion of data transmission.

10. The system according to claim 9, wherein the acknowledge signal is generated and output whenever the corresponding semiconductor device receives each of the device ID, the command, and the sub-ID.

11. The system according to claim 9, wherein the controller compares the device ID of the sub-ID storage protocol with the set device ID using the sub-ID storage protocol,
wherein when the device ID of the sub-ID storage protocol is identical to the set device ID, the controller confirms whether the command is a command to store the sub-ID, and when the command is the command to store the sub-ID and the sub-ID is not stored, the controller stores the sub-ID of the received data as the sub-ID of the semiconductor device and turns on the switch.

12. The system according to claim 11, wherein the controller erases the sub-ID stored in each of the semiconductor devices, turns off the switch, re-stores the sub-ID, and turns on the switch, using a sub-ID reset protocol for resetting the sub-ID.

13. The system according to claim 1, wherein the switch is turned off when a power voltage is initially applied or the sub-ID is not stored, and turned on when the sub-ID is stored.

14. The system according to claim 1, further comprising at least one control unit.

15. The system according to claim 1, further comprising at least one second semi-conductor device connected to the semiconductor devices in parallel and assigned a different device ID, each second semiconductor device for receiving the clock signal and the data.

16. A method of granting identifications (IDs) in a serial communication system, comprising:
outputting, by a control unit, a clock signal and data including a sub-ID; and
receiving, by a semiconductor device, the data, storing the sub-ID of the received data excluding a set device-ID, and turning on a switch to transmit the data to the next stage.

17. The method according to claim 16, wherein storing the ID and controlling the switch comprises:
detecting a start signal indicating the beginning of data transmission in response to the clock signal, and receiving the device ID included in the data;
setting and storing the sub-ID of the data;
turning on the switch; and
finishing storing the sub-ID and standing by to receive next data.

18. The method according to claim 17, wherein storing the sub-ID of the data comprises:
confirming the received device ID and a command; and
confirming the stored sub-ID and storing the sub-ID of the data.

19. The method according to claim 18, wherein confirming the device ID and the command comprises:
comparing the set device ID with the received device ID and receiving the device ID included in the data when the set device ID is not identical to the received device ID;
receiving the command included in the data; and
confirming whether the received command is a command to store the sub-ID, and performing a subsequent step when the received command is a command to store the sub-ID.

20. The method according to claim 18, wherein confirming the stored sub-ID and storing the sub-ID of the data comprises:
confirming whether the sub-ID is stored, determining that the received command is erroneous, finishing storing the sub-ID, and standing by to receive next data when the sub-ID is stored;
receiving the sub-ID included in the data when the sub-ID is not stored; and
storing the received sub-ID.
